(19) United States
(12) Patent Application Publication
(10) Pub. No.: US 2021/0313697 A1
(43) Pub. Date: Oct. 7, 2021

(54) PATCH ANTENNA

(71) Applicant: STAR Systems International Limited, Kwai Chung (HK)

(72) Inventor: Chi Lun MAK, Kwai Chung (HK)

(21) Appl. No.: 16/838,398

(22) Filed: Apr. 2, 2020

(51) Int. Cl. H01Q 9/04; H01Q 5/371; H01Q 21/06

(52) U.S. Cl. CPC H01Q 9/0457; H01Q 5/371; H01Q 9/0435; H01Q 21/065; H01Q 9/0478

(57) ABSTRACT

A patch antenna, comprising: a conductive element; and a first feed point; wherein the first feed point splits into at least two branches which are connected electrically to the conductive element. The two branches are configured such that a cross polarization in a H-plane is suppressed, and antenna gain is increased.

### TECHNICAL FIELD

The present disclosure relates to a patch antenna.

### BACKGROUND

A patch antenna is also known as a microstrip antenna or a printed antenna. It is widely used nowadays especially in the wireless communications industries. For example, patch antennas are used in Radio Frequency Identification (RFID) Technology implemented in logistics, supply chains, electronic toll collection etc., mobile communications such as cell tower antenna or base station antenna, mobile phone antenna etc., consumer electronics and Global Positioning Satellite (GPS) devices.

A patch antenna is low cost, low in profile, and easily fabricated, which may be mounted on a flat or curved surface. It usually comprises a piece of sheet or “patch” of metal of different sizes and shapes, mounted over a larger sheet of metal called a ground plane. The “patch” of a patch antenna acts as the radiating element of the patch antenna. It may be realized by using a standalone metallic plate or printed directly onto a Printed Circuit Board (PCB).

The structure of a basic patch antenna comprises a radiating element, a ground plane, a dielectric substrate, and a feed point. As mentioned previously, a radiating element may be a metal plate of any size and any shape as long as it suits the implementation of the antenna depending on its application. A ground plane is often a metal sheet larger than the radiating element, and a dielectric substrate is positioned between the ground plane and the radiating element. In some cases, a patch antenna may be without a ground plane. It may utilise a conductive surface, though not ideal and rare, where the patch antenna is attached to, as its ground plane. A feed point is where a signal is fed in or received from the radiating element. There are many different feeding or excitation methods comprising, but not limited to, probe-fed and edge-fed methods.

It is known that a basic patch antenna where there is only a single patch has a directional radiation pattern with gain of around 6 to 8 dBi. To obtain higher gain, it is possible to introduce more radiating elements (i.e. more “patches”) such as in the case a patch antenna array design.

In patch antenna array design, the multiple radiating elements are arranged with designed spacing (usually around 0.5 to 0.8 free-space wavelength between every two elements), and the multiple radiating elements are connected by a designed feed network. Common types of designed feed networks in patch antenna array designs are series feed networks and corporate (or parallel) feed networks. As a ground plane is usually bigger in area than the corresponding radiating element(s), a patch array antenna requires a bigger ground plane than a single basic patch antenna and the overall antenna size of a patch array antenna is usually much bigger than the size of a single basic patch antenna.

In light of the above, this disclosure offers a novel and inventive patch antenna which has improved gain while having smaller size than a patch array antenna.

### SUMMARY

According to a first aspect of the present invention, there is provided a patch antenna, comprising: a conductive element; and a first feed point; wherein the first feed point splits into at least two branches which are connected electrically to the conductive element.

In one form, the two branches are configured such that a cross polarization in a H-plane is suppressed, and antenna gain is increased.

In one form, the patch antenna further comprises: a dielectric substrate; wherein the conductive element is on the dielectric substrate.

In one form, the patch antenna further comprises: a ground plane with an area larger than that of the conductive element; wherein the ground plane is at an opposite side of the dielectric substrate opposing the conductive element.

In one form, the dielectric substrate comprises an air or vacuum layer.

In one form, the conductive element and the at least two branches are within a same plane on the substrate.

In one form, the conductive element is with four sides; and wherein the two branches are connected electrically to the conductive element at one same side of the four sides.

In one form, the conductive element is rectangular and the width to length ratio is ≥1.5.

In one form, the at least two branches split into at least three branches to connect electrically to the conductive element.

In one form, the patch antenna further comprises a second feed point, wherein the second feed point splits into at least two branches which are connected electrically to the conductive element.

In one form, the first feed point and the second feed point feed the patch antenna from different directions.

In one form, the patch antenna further comprises a protective layer over the conductive element.

In one form, the patch antenna further comprises a superstrate over the conductive element.

In one form, the patch antenna further comprises an inset-fed structure at where at least one of the at least two branches is connected electrically to the conductive element.

In one form, the patch antenna further comprises slots within the conductive element.

According to another aspect of the present invention, there is provided an array antenna comprising a plurality of the patch antenna of the first aspect.

According to another aspect of the present invention, there is provided a superstrate printed circuit board (PCB) antenna, comprising: a superstrate; a ground plane; a dielectric substrate; a conductive element on the dielectric substrate and below the superstrate; a shorting pin to provide a DC ground to the conductive element; and a first feed point; wherein the first feed point splits into at least two branches which are connected electrically to the conductive element.

### BRIEF DESCRIPTION OF DRAWINGS

Embodiments of the present invention will be discussed with reference to the accompanying drawings wherein:

FIG. 1 depicts one exemplary embodiment of a patch antenna of the present disclosure;

FIG. 2 is a top view of the embodiment of FIG. 1;

FIG. 3 shows that the feed point of the embodiment of FIG. 1 is approximately at half the width from the side of the patch;

FIG. 4 shows a simulated return loss S₁₁ of the patch antenna of FIG. 1;

FIG. 5 shows a simulated gain of the patch antenna of FIG. 1;

FIG. 6 shows a simulated radiation pattern at 915 MHz of the patch antenna of FIG. 1;

FIGS. 7A to 7D shows the vector surface current distribution at 915 MHz of the patch antenna of FIG. 1;

FIG. 8 shows a traditional patch antenna of similar dimension with a single feed;

FIG. 9 shows a simulated return loss S₁₁ of the traditional patch antenna of FIG. 8;

FIG. 10 shows a simulated gain of the traditional patch antenna of FIG. 8;

FIG. 11 shows the radiation pattern at 915 MHz of the traditional patch antenna of FIG. 8;

FIGS. 12A to 12D show the vector surface current distribution at 915 MHz of the traditional patch antenna of FIG. 8;

FIG. 13 shows another embodiment of the present disclosure;

FIG. 14 shows another embodiment of the present disclosure;

FIGS. 15 to 17 shows further different embodiments of the present disclosure;

FIG. 18 shows a more complex patch antenna; and

FIG. 19 to FIG. 21 show yet other embodiments of the present disclosure.

### DESCRIPTION OF EMBODIMENTS

The present disclosure introduces a novel and inventive patch antenna.

In a broad form, the new and inventive patch antenna comprises a conductive element and a first feed point wherein the first feed point splits/branches into at least two branches which are connected electrically to the conductive element.

The conductive element acts as the radiating element of the patch antenna, and the feed point feeds signals to or receives signals from the antenna.

The term “connected electrically” means the feed point is connected physically to the radiating element, and the signals between the feed point and the radiating element travel in a conductive medium, and no coupling gap is intentionally designed or involved in the conductive medium connecting the feed point and the radiating element.

The term “splits” and “branches” (verb) simply means changes from one to more than one. It doesn't require that the total amount after the split is the same as the amount before the split. In this context of tracks of a patch antenna, split(s) simply means a track or a line changes to more than one track or line. It doesn't require that the total width of the more than one track to be the same of the total width of the originating track.

The term “branches” (noun) means different paths or tracks or lines. One or each of the branches may be broader in width than the source of the branches. For example, the feed point may be connected to a printed track of X mm width and two branches of X+ mm width splits from the printed track of X mm.

The concept of the present disclosure is completely different from the known corporate feed method (sometimes also known as a parallel feed method). Based on a corporate feed method, a line at a feed point (in short feed line) splits into two or more branches and each of the branches are connected to a separate patch.

The disclosure goes against such teaching. Rather than having separate patches which are fed by a single branch from a feed line, the disclosure requires at least a patch which is connected to at least two branches of a feed line. The disclosure does not require multiple patches, but may include the case where multiple of such patches (fed by at least two branches) are present. The disclosure may also include the case where such patch (fed by at least two branches) is used in combination with an array antenna, and/or other single branch fed patches.

Turning the focus to a single patch which is fed by at least two branches, the design aim is to achieve a higher gain of over 10 dBi for such a single patch, with size comparable with a known single patch antenna (i.e. single branch fed). Unwanted cross-polarization radiations are also to be reduced.

The patch antenna of the present disclosure not only maintains the benefits of microstrip or printed patch antenna design, but also has the benefit of high gain and reduced size as compared with an array antenna. If required, multiple of the patch antenna of the present disclosure may be combined in an array antenna for an even higher antenna gain (when compared to similar number of patch elements in antenna array design).

The implementation of the patch antenna involves feeding a single patch on the same side with more than one branch from a feed line. In other words, the single patch is excited with the same fundamental mode as in using a single-feed method. The unwanted cross polarization in H-plane may be suppressed and therefore the antenna gain may be increased.

The multiple connection to a single radiating patch at one side then acts as multiple feed points to excite the fundamental mode of the patch antenna, and at the same time, the higher order mode, which contributes some cross polarization, will cancel each other so the overall cross polarization may be suppressed.

Further the design is simple and elegant in that in the most basic form only a single patch is used to increase antenna gain. There is no requirement for a parasitic radiating element, multiple radiating elements, and an array design for enhancing antenna gain. Of course, parasitic radiating elements, multiple radiating elements and array design may be added to the patch antenna of the present disclosure if deemed suitable by a designer depending on applications of the patch antenna.

As best understood, the present disclosure teaches away from known prior art. For linear polarization radiation, it is common practice to have a single radiating patch element fed by a single feed point. In an array design involving multiple patches, the patches are arranged in parallel feed form or series feed form. In the case of parallel feed form, each radiating element is fed by a single branch. In the case of a series feed form, each radiating element is fed at one side and all radiating elements are fed in series. Combination of parallel feed form or series feed form is possible, but again, none of them involves feeding a patch with two branches at one side. In the case of a Printed Circuit Board (PCB), no known patch is fed by two microstrip lines at one side from a single feed. This is completely different from a series feed form, where one microstrip line is connected to a first patch at one side as its feed line, while there is another microstrip line coming out, which connecting the first patch at the opposite side to a second patch as the feed of the second patch, and so on for the 3^{rd} patch, 4^{th} patch, etc.

For circular polarization, some single patch elements may be fed by two feed points correspondingly at two different orthogonal sides. This is different for two branches from a same feed line. The two feed points for circular polarization drives different sides of the patch of the patch antenna to excite two orthogonal modes.

Further, since one feed point is good enough for a single patch, there is no reason why a person skilled in the art would split the one feed into two or more connections to the single patch, as there would mean increase in the design complexity, and increase in microstrip line loss, and use of extra space, material and cost.

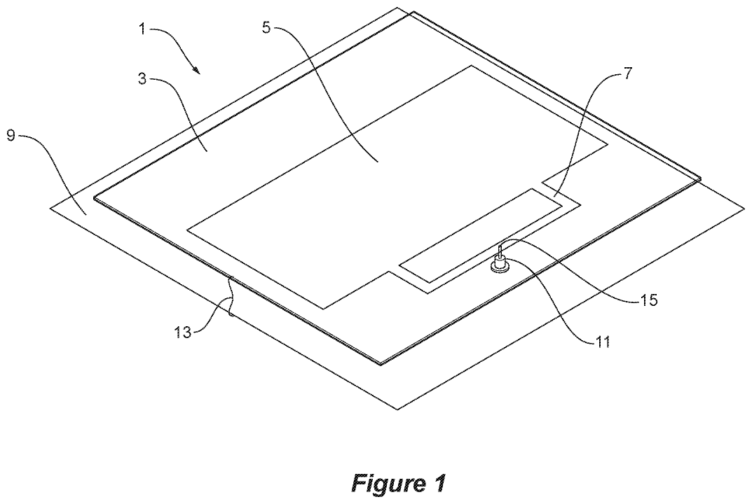

FIG. 1 depicts one embodiment of the present disclosure. In this embodiment, there is provided a PCB printed antenna 1 with linear polarization. There is a patch 5 acting as a radiating element, printed on the top of the PCB 3. There is a single feed point 15 from an RF connector 11. The single feed point 15 connects to microstrip lines 7, which branches in two directions before connecting electrically to the patch 5. There is a dielectric substrate 13 between the patch 5 and the ground plane 9. Common dielectric substrate material is FR-4, but other material may be used. In some cases, open gap, or even vacuum gap, or a combination, such as FR-4 and air gap, may be implemented as the dielectric substrate material. The ground plane 9 may be part of the PCB, and may be an external ground plane.

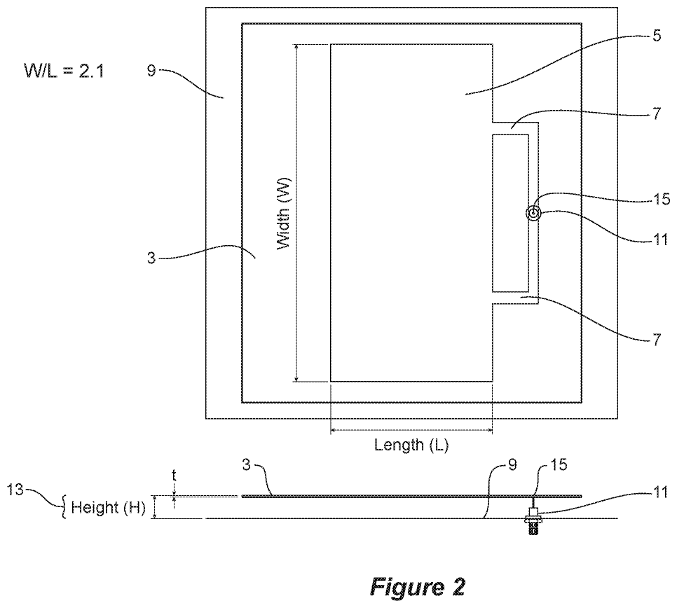

FIG. 2 is a top view of the embodiment of FIG. 1. It shows the width (W) and length (L) of the patch 5. For simplicity of discussion, the direction of the feed point feeds the patch is considered as the front for this embodiment, thus the side the microstrip lines 7 feed the patch is the width. While not a necessity, it was discovered that a width to length ratio (W/L) of 1.5 works better than others.

In this embodiment, the L represents the resonant length of the radiating patch element, and theoretically it is around a half free-space wavelength (0.5λ₀) long when the substrate 13 thickness is very thin. The resonant length controls the resonant frequency, f₀ of the patch 5. The distance of the patch 5 from the ground plane 9 is represented by height (H).

The W and H may be varied based on available space and performance requirements. Conventional patch 5 has a W equal to around 1.0 L to 1.5 L, and H is around 0.03 free-space wavelength, λ₀.

To enhance the antenna gain, the embodiment as shown has the following parameters: W=250 mm (0.76λ₀) and L=118 mm (0.36λ₀) which has a W/L=2.1, and H is around 0.05λ₀, which is 17 mm (assuming center operating frequency, f₀, at 915 MHz). The size of the PCB 3 is 280×250×1 mm and the PCB is the common FR4 PCB. There is an air substrate between the PCB and the ground plane in this embodiment. The size of the ground plane 9 is 304×304 mm.

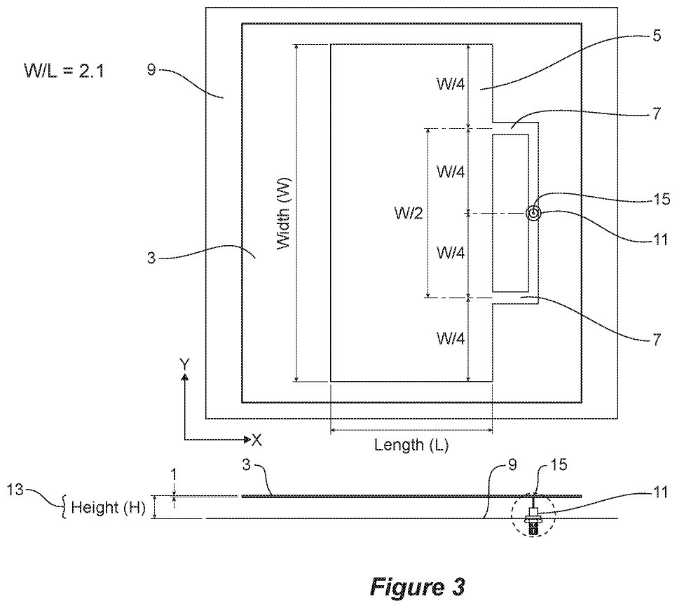

Further, in this embodiment, as shown in FIG. 3, the feed point is approximately at half the width from the side of the patch 5. The two microstrip connections are at approximately quarter and three quarter width from the side of the patch 5. The FR4 PCB 3 is 1 mm thick, and air gap of 16 mm is between the FR4 PCB and the ground plane. Therefore, the height (H) is 17 mm.

It is noted that when W increases, the unwanted cross-polarization increases (getting stronger), which may limit the achievable antenna gain.

The proposed feeding mechanism suppresses the unwanted cross-polarization radiation, and therefore a higher antenna gain may be achieved. Over 10 dBi in FCC band (902-928 MHz) is obtained using the patch antenna shown in FIG. 1.

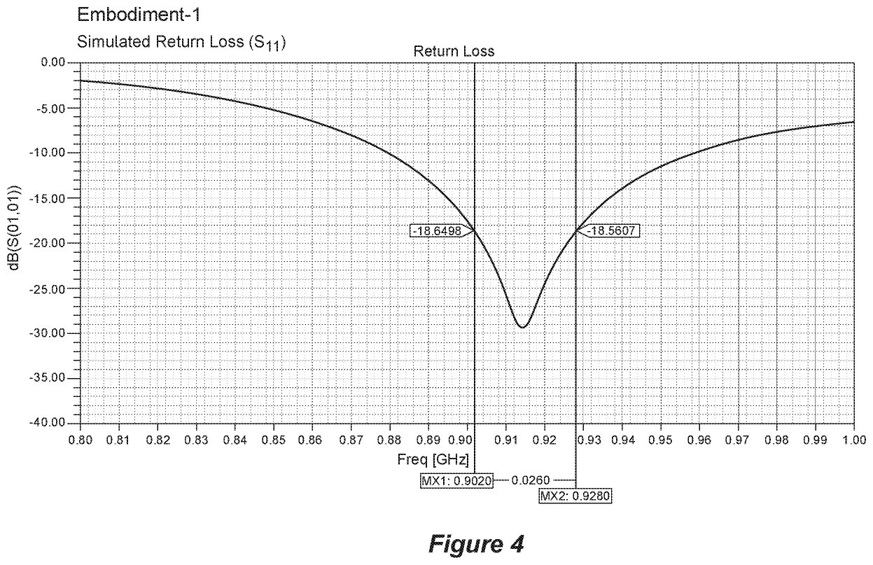

FIG. 4 shows a simulated return loss S₁₁ of the patch antenna of FIG. 1. As may be seen, within the operating frequency band of 902-928 MHz (FCC band), the return loss is below −18 dB.

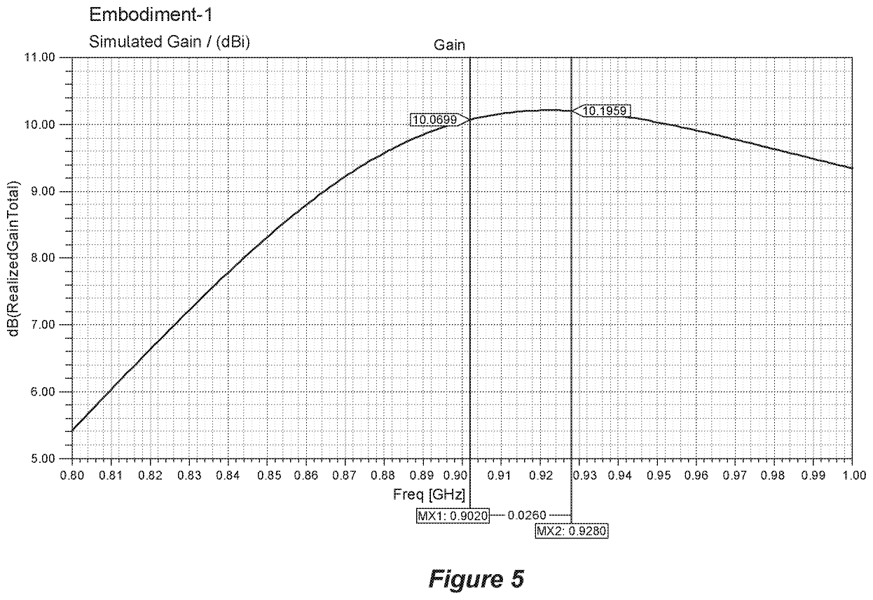

FIG. 5 shows a simulated gain of the patch antenna of FIG. 1. As may be seen, the antenna gain is more than 10 dBi within the operating frequency band of 902-928 MHz (the FCC band).

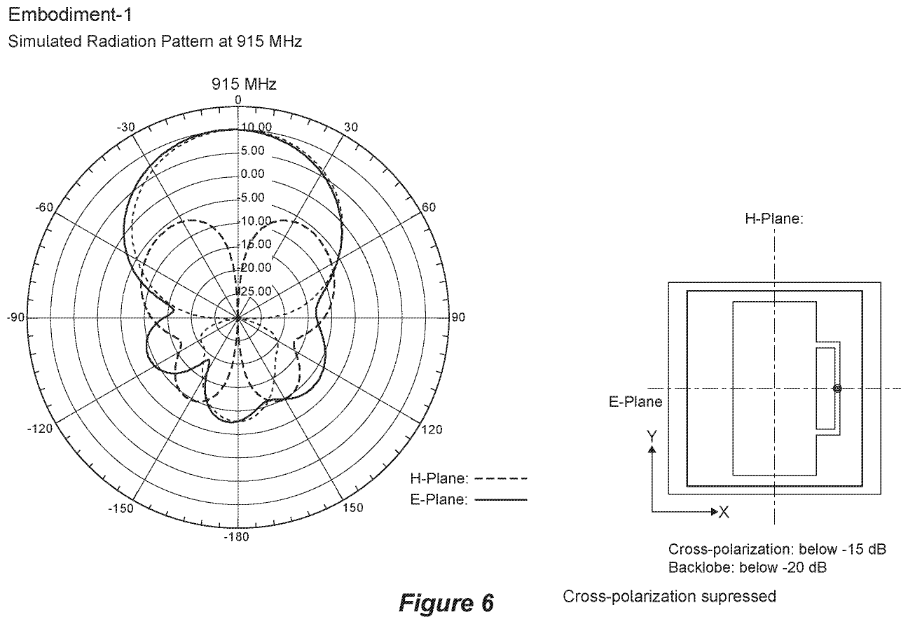

FIG. 6 shows a simulated radiation pattern at 915 MHz of the patch antenna of FIG. 1, which demonstrates an improved suppression of cross-polarization in the H-plane with cross-polarization of below −15 dB and a back lobe of below −20 dB.

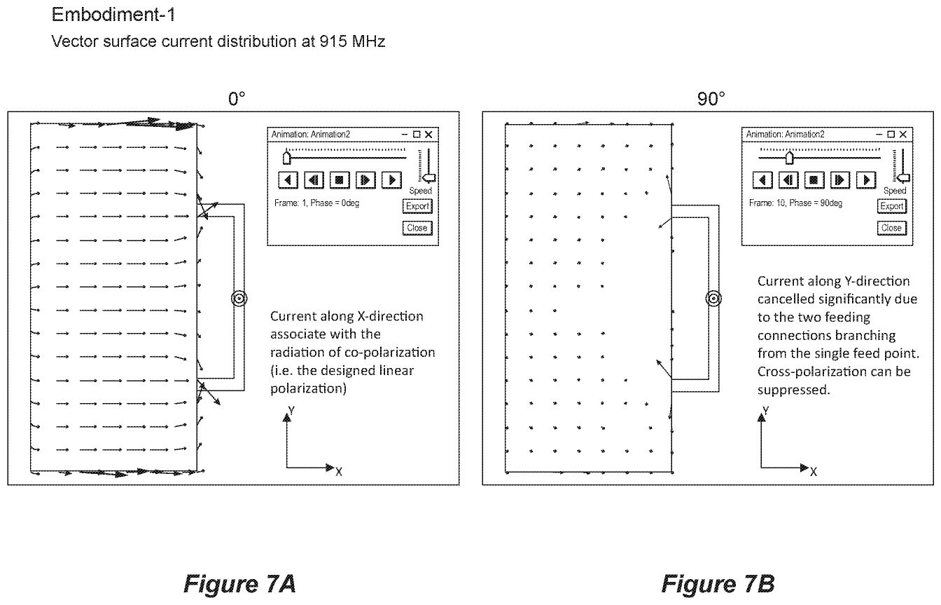

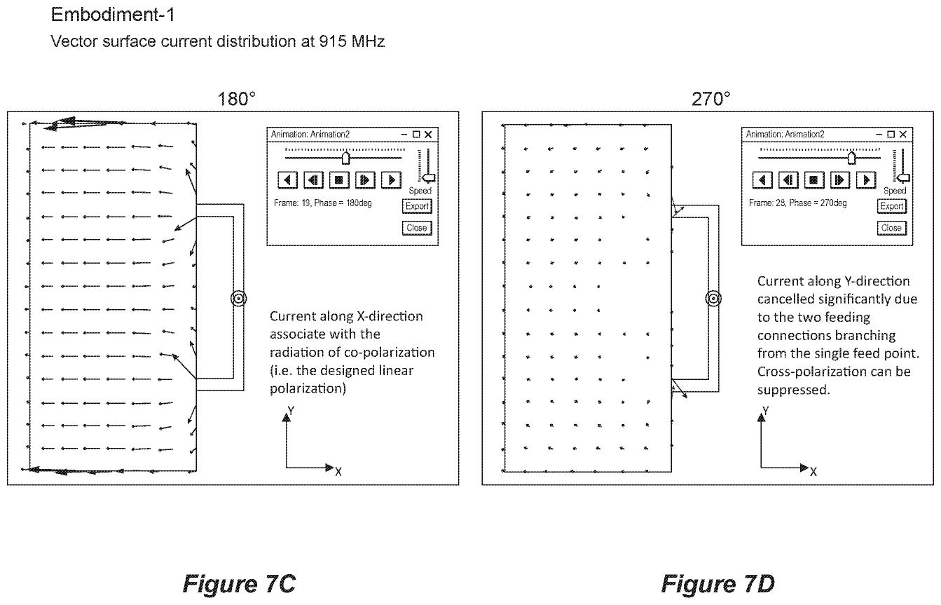

FIG. 7A to 7D shows the vector surface current distribution of the patch antenna of FIG. 1 at 915 MHz at phase=0°, 90°, 180° and 270°. It may be seen from FIG. 7A that current along X-direction associate with the radiation of co-polarization (i.e. the designed linear polarization). In FIG. 7B, current along Y-direction is cancelled significantly due to the two feeding connections branching from the single feed point 15, which results in cross-polarization suppression. In FIG. 7C, current along X-direction associate with the radiation of co-polarization (i.e. the designed linear polarization). In FIG. 7D, current along Y-direction is cancelled significantly due to the two feeding connections branching from the single feed point 15, which results in cross-polarization suppression.

FIG. 8 shows a traditional patch antenna of similar dimension with a single feed. There is a circular slot surrounding the feed point. The traditional patch antenna is compared with the patch antenna of FIG. 1. The traditional patch antenna used for the comparison has the following dimension: L=122 mm (0.37λ₀), W=220 mm (0.67λ₀) which has a W/L=1.8 and H=17 mm (0.05λ₀). The FR4 PCB is with a thickness of 1 mm, and the size of the ground plane 304×304 mm with size of the FR4 PCB=280×190 mm. It was found that this traditional design has lower return loss (S₁₁) at below −24 dB, but the gain is at most 9.6 dBi.

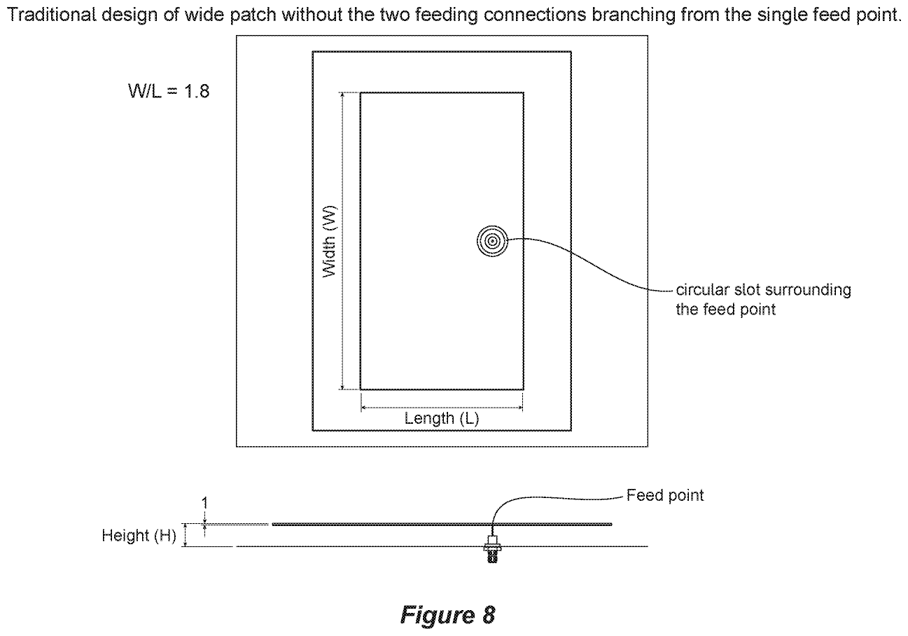

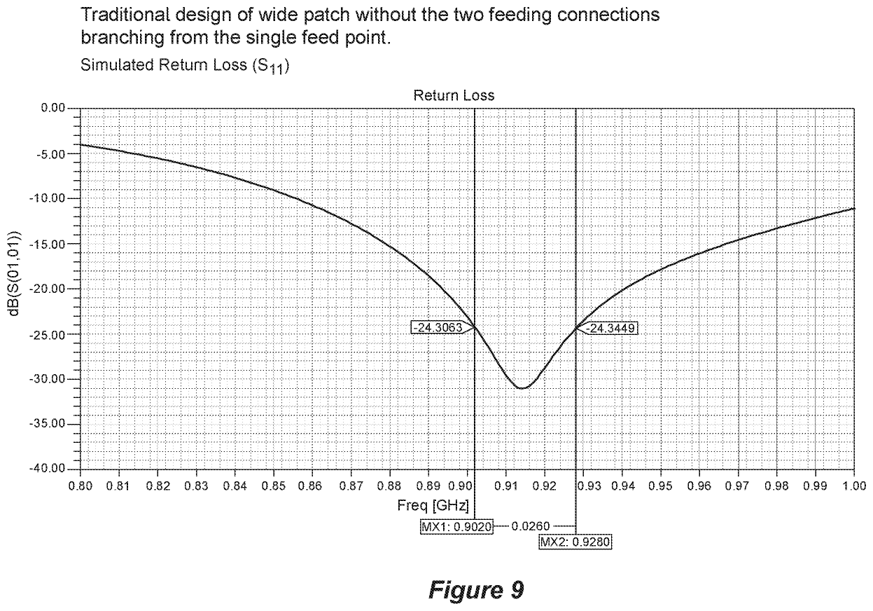

FIG. 9 shows a simulated return loss S₁₁ of the traditional patch antenna of FIG. 8. As may be seen, within the operating frequency band 902-928 MHz (FCC band), the return loss is below −24 dB.

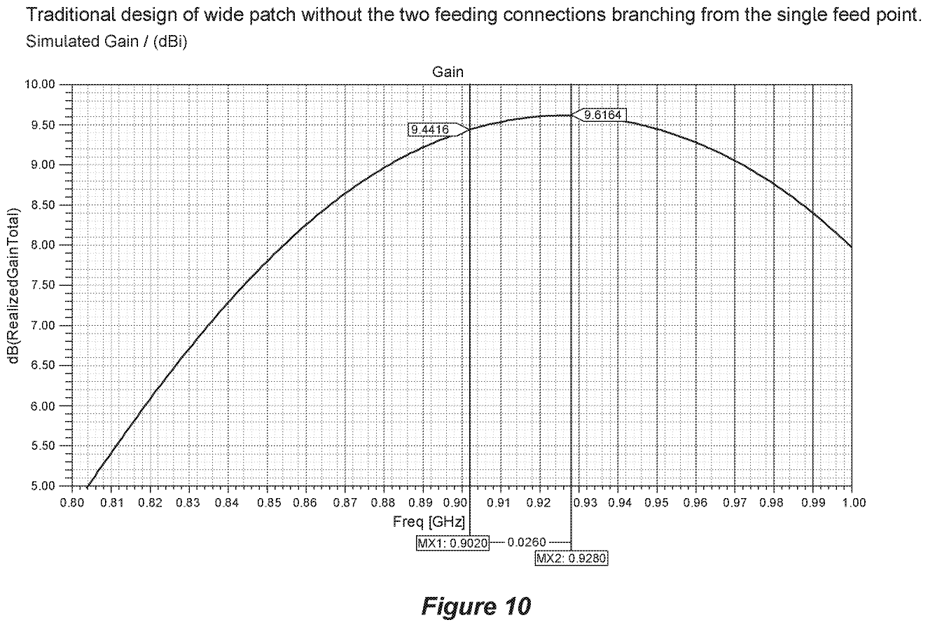

FIG. 10 shows a simulated gain of the patch antenna of FIG. 8. As may be seen, the antenna gain is only 9.4 to 9.6 dBi, clearly below the antenna gain of more than 10 dBi, shown in FIG. 5, of the patch antenna of FIG. 1, within the operating frequency band 902-928 MHz (FCC band).

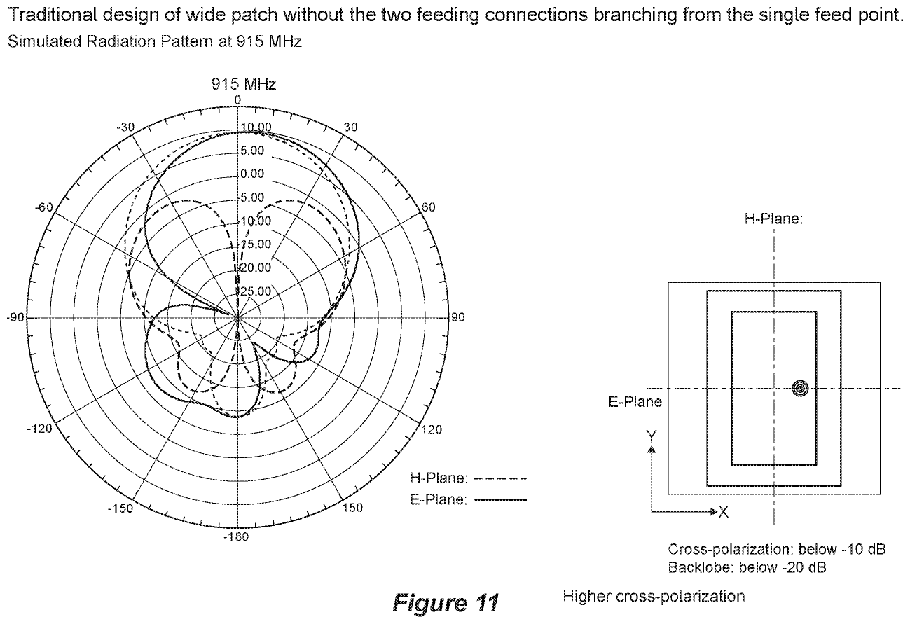

The traditional patch antenna of similar dimension with a single feed of FIG. 8 is also simulated to further compare with the antenna of FIG. 1. FIG. 11 shows the radiation pattern at 915 MHz of this traditional patch antenna demonstrates a high cross-polarization in the H-plane. It is also noted that the achievable gain of this traditional patch antenna is limited by the high unwanted cross-polarization. As may be observed, the traditional patch antenna has a high cross-polarization of below −10 dB (higher than the −15 dB cross-polarization level shown in FIG. 6) and back lobe of below −20 dB.

It is well known that the wider or bigger the antenna or the radiating patch, the higher the potential gain. However, the higher the ratio of W/L, the stronger the cross-polarization, which limits the achievable gain. The current invention shows a lower cross-polarization even with a higher ratio of W/L, and therefore a higher antenna gain can be attained without using conventional gain enhancement techniques.

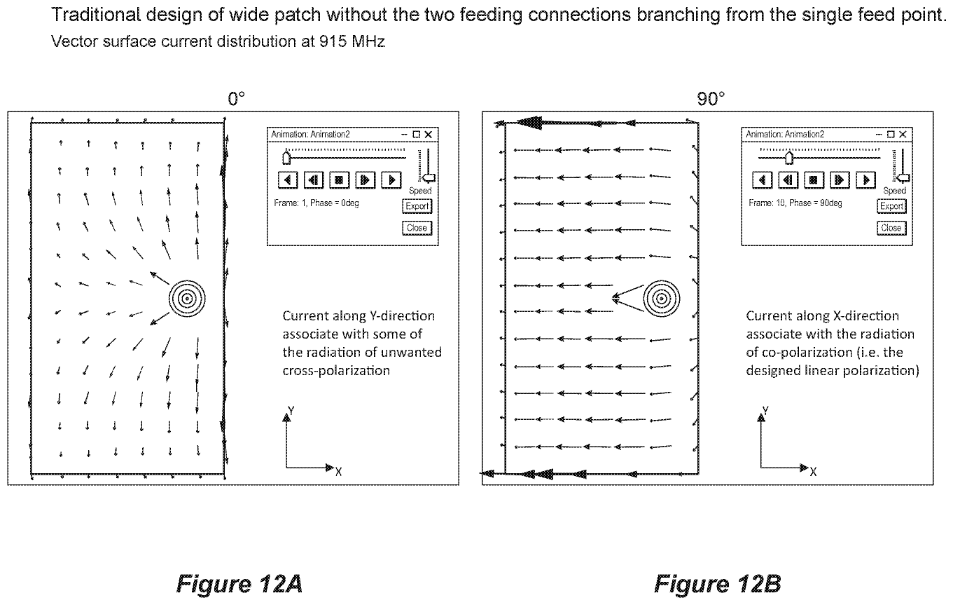

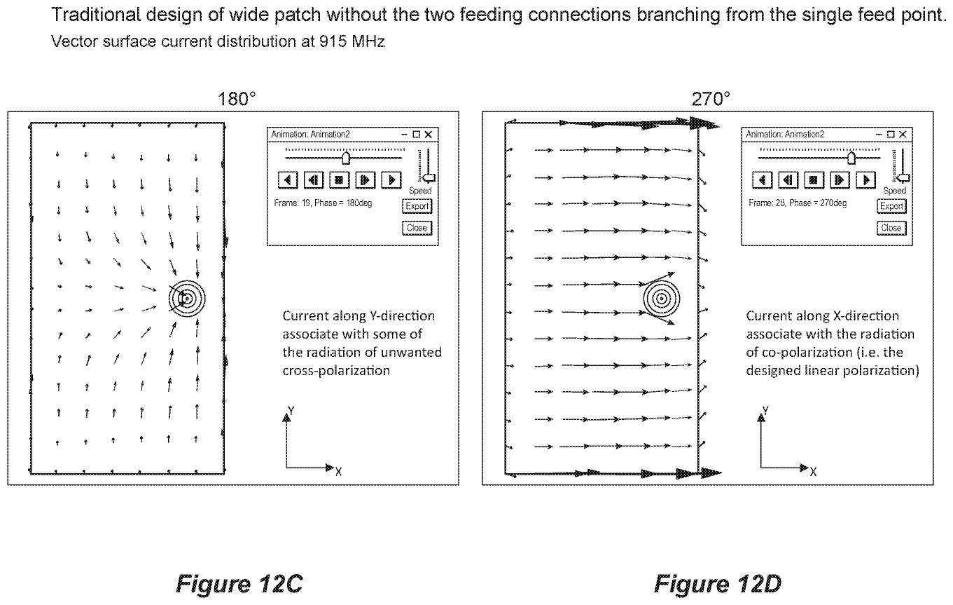

FIGS. 12A to 12D show the vector surface current distribution of the traditional patch antenna at 915 MHz at phase=0°, 90°, 180° and 270°. It may be seen from FIG. 12A that current along Y-direction associate with some of the radiation of unwanted cross-polarization. In FIG. 12B, current along X-direction associate with the radiation of co-polarization (i.e. the designed linear polarization). In FIG. 12C, current along Y-direction associate with some of the radiation of unwanted cross-polarization. In FIG. 12D, current along X-direction associate with the radiation of co-polarization (i.e. the designed linear polarization).

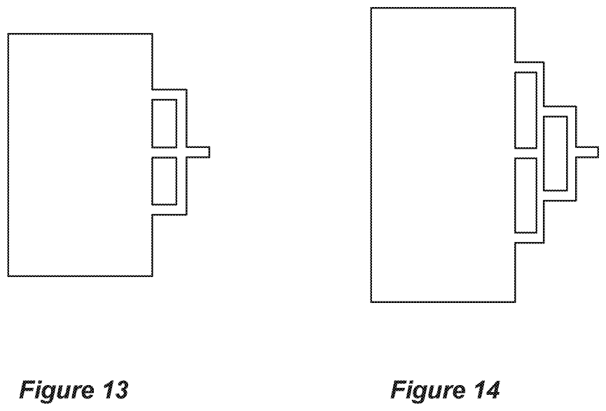

FIGS. 13 and 14 show other embodiments of the present disclosure. In particular, FIG. 13 shows a patch antenna which applies the same concept with the patch antenna of FIG. 1 but with three microstrip lines branching from a single feed point to connect the patch at three locations at the same side of the patch. FIG. 14 is another embodiment where there are two layers of microstrip network. In the first layer, a single feed point branches into two microstrip lines. In the second layer, the two microstrip lines branch into three microstrip lines before connecting the patch. The different embodiments may be used to achieve different operating parameters for the patch antenna, but with improved gain as discussed with respect to the embodiment of FIG. 1.

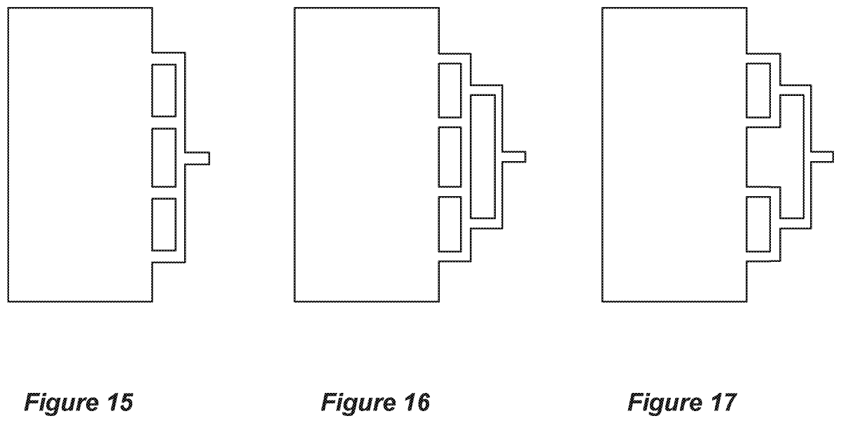

FIGS. 15 to 17 show further different embodiments. In particular, FIG. 15 shows an embodiment where the single feed point directly branches into four microstrip lines, without first branches into two. In other words, linear incremental of microstrip lines from the feed point need not be two, then three, then four. This is further illustrated by the embodiments as shown in FIG. 16 and FIG. 17. In FIG. 16, the microstrip lines branch to four microstrip lines in the second layer from two microstrip lines in the first layer. Similarly, the microstrip lines branch to four microstrip lines in the second layer from two microstrip lines in the first layer in the embodiment in FIG. 17 but with disconnected branches in the second layer, unlike the embodiment in FIG. 16 where four microstrip lines in the second layer are still interconnected.

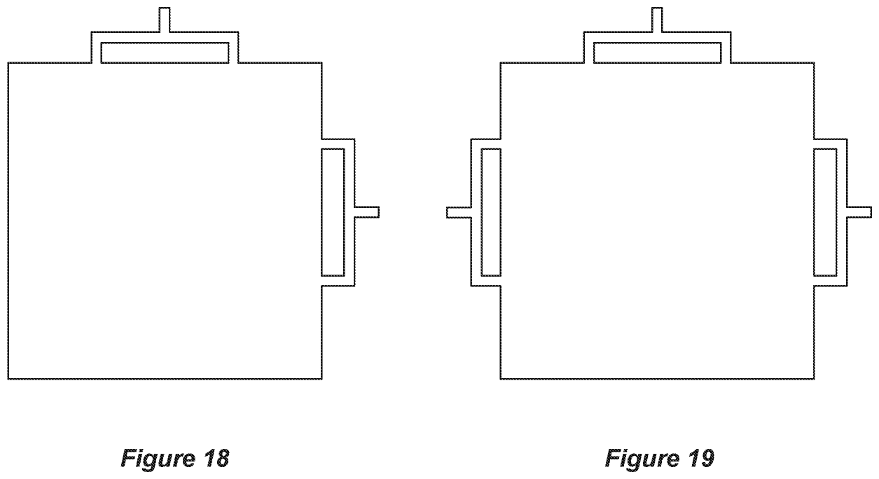

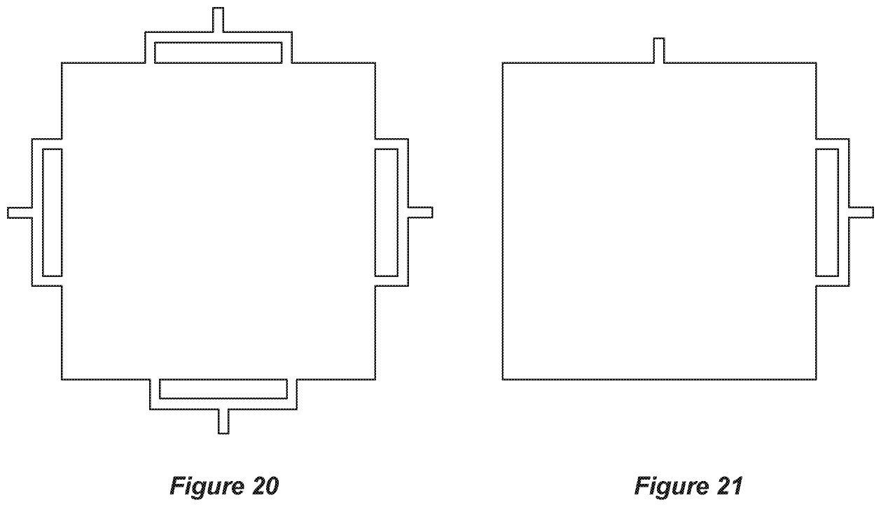

FIG. 18 shows a more complex patch antenna. This patch antenna has two feed points. Each feed point is the same just like the embodiment of FIG. 1, where two microstrip lines branch from each of the feed points to connect the patch antenna. In this embodiment, the two sets of microstrip lines connect the patch at different adjacent sides (in this case, two orthogonal sides), but it may be at opposing sides as well. FIG. 19 shows another embodiment. This patch antenna has three feed points. Each feed point is the same just like the embodiment of FIG. 1, where two microstrip lines branch from each of the feed points to connect the patch antenna. FIG. 20 shows yet another embodiment. This patch antenna has four feed points. Each feed point is the same just like the embodiment of FIG. 1, where two microstrip lines branch from each of the feed points to connect the patch antenna.

FIG. 21 shows yet another embodiment. This embodiment is similar to the embodiment of FIG. 18, where there are two feed points feeding the patch from two orthogonal sides. One of the feed point splits into at least two branches which are connected electrically to the patch. The other feed point connects to the patch through a single microstrip line. Other embodiments may have a combination of (1) at least one feed point splitting into at least two branches which are connected electrically to the patch; and (2) one or more of conventional connection methods connecting other feed point(s) to the patch.

All previous embodiments show the patch being a rectangle or square, and that at the most basic form, there is a pair of microstrip lines branching from a single feed point to connect the patch of the patch antenna. Further, it has been shown that there are at least two connection points from a feed point on a same side of a patch, for example, it may have n connections to a single patch element on the same side (n≥2).

However, the shape of the patch may be other shapes, for example, a triangular, circle, an oval, or a geometrical shape, or even an irregular shape. In those cases, the concept of the present disclosure may be applied in that two or more microstrip lines branch from a single feed point to connect a single patch, which may be a shape different from a rectangle as described above.

Further, a protective layer may be applied over the patch antenna to protect the patch antenna from being damaged. For example, a physical plastic shield, or a Radome, may be used. The protective layer may be taken into account when designing the patch antenna, so that it will not affect the performance of the patch antenna. Further, a superstrate may be applied over the patch of the patch antenna to act as a protective layer.

In some embodiments, an inset-fed structure may be used where at least one of the at least two branches is connected electrically to the conductive element. Further tuning and modifications may also be implemented, such as introducing slots within the patch of the patch antenna.

While the patch antenna of various embodiments of the present disclosure may function independently, the patch antenna may also be used as elements of an array antenna. In such a case, an array antenna may comprise more than one of the patch antennas of the present disclosure, such as the one depicted in FIG. 1.

While there may be many ways a patch antenna is implemented, the following is one practical example. The patch antenna is a printed circuit board (PCB) patch antenna, comprising: a superstrate, a ground plane; a dielectric substrate; a conductive element (i.e. the patch of the patch antenna) on the dielectric substrate and below the superstrate; a shorting pin to provide a DC ground to the conductive element; and a first feed point; wherein the first feed point splits into at least two branches which are connected electrically to the conductive element. The shorting pin provides an electrical connection between the patch and the ground plane, so the patch is DC grounded.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement or any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A patch antenna, comprising:
a conductive element; and
a first feed point;
wherein the first feed point splits into at least two branches which are connected electrically to the conductive element.

2. The patch antenna of claim 1, wherein the two branches are configured such that a cross polarization in a H-plane is suppressed, and antenna gain is increased.

3. The patch antenna of claim 1, further comprises:
a dielectric substrate;
wherein the conductive element is on the dielectric substrate.

4. The patch antenna of claim 3, further comprises:
a ground plane with an area larger than that of the conductive element;
wherein the ground plane is at an opposite side of the dielectric substrate opposing the conductive element.

5. The patch antenna of claim 3, wherein the dielectric substrate comprises an air or vacuum layer.

6. The patch antenna of claim 1, wherein the conductive element and the at least two branches are within a same plane on the substrate.

7. The patch antenna of claim 1, wherein the conductive element is with four sides; and wherein the two branches are connected electrically to the conductive element at one same side of the four sides.

8. The patch antenna of claim 7 wherein the conductive element is rectangular and the width to length ratio is ≥1.5.

9. The patch antenna of claim 1, wherein the at least two branches split into at least three branches to connect electrically to the conductive element.

10. The patch antenna of claim 1, further comprises a second feed point, wherein the second feed point splits into at least two branches which are connected electrically to the conductive element.

11. The patch antenna of claim 9, wherein the first feed point and the second feed point feed the patch antenna from different directions.

12. The patch antenna of claim 1, further comprises a protective layer over the conductive element.

13. The patch antenna of claim 1, further comprises a superstrate over the conductive element.

14. The patch antenna of claim 1, further comprises an inset-fed structure at where at least one of the at least two branches is connected electrically to the conductive element.

15. The patch antenna of claim 1, further comprises slots within the conductive element.

16. An array antenna comprising a plurality of the patch antenna of claim 1.

17. A printed circuit board (PCB) antenna, comprising:
a superstrate;
a ground plane;
a dielectric substrate;
a conductive element on the dielectric substrate and below the superstrate;
a shorting pin to provide a DC ground to the conductive element; and
a first feed point;
wherein the first feed point splits into at least two branches which are connected electrically to the conductive element.
